(19) United States
(12) Patent Application Publication
(10) Pub. No.: US 2025/0049022 A1
(43) Pub. Date: Feb. 13, 2025

(54) BIOPESTICIDE FORMULATIONS BASED ON PICKERING EMULSION

(71) Applicant: THE STATE OF ISRAEL, MINISTRY OF AGRICULTURE & RURAL DEVELOPMENT, AGRICULTURAL RESEARCH, Rishon Lezion (IL)

(72) Inventors: Guy MECHREZ, Adi (IL); Dana MENT, Ness Ziona (IL); Karthik ANANTH MANI, Rishon Lezion (IL); Noga YAAKOV, Ramla (IL)

(21) Appl. No.: 18/722,566

(22) PCT Filed: Dec. 22, 2022
(86) PCT No.: PCT/IL2022/051374

§ 371 Date: Jun. 20, 2024

Related U.S. Application Data
(60) Provisional application No. 63/292,713, filed on Dec. 22, 2021.

(51) Int. Cl. A01N 25/04; A01N 25/08; A01N 25/24; A01N 63/23; A01P 1/00; A01P 3/00; A01P 5/00; A01P 7/04

(52) U.S. Cl. CPC A01N 25/04; A01N 25/08; A01N 25/24; A01N 63/23; A01P 1/00; A01P 3/00; A01P 5/00; A01P 7/04

(57) ABSTRACT

Provided herein is a composition comprising a Pickering emulsion comprising a plurality of core-shell particles encapsulating a microbial cell and/or a spore thereof. Furthermore, a method for controlling a pest on or within a plant or at the area under cultivation is provided.

### CROSS-REFERENCE TO RELATED APPLICATIONS

This application claims the benefit of priority of U.S. Provisional Patent Application No. 63/292,713, titled “BIOPESTICIDE FORMULATIONS BASED ON PICKERING EMULSION”, filed Dec. 22, 2021, the contents of which are incorporated herein by reference in their entirety.

### FIELD OF THE INVENTION

The present invention is in the field of Pickering emulsions, specifically Pickering emulsions comprising bacteria within the core of colloidosome.

### BACKGROUND OF THE INVENTION

Biological pest control has a tremendous ecological advantage over conventional pesticide usage. Microbial biopesticides, including bacteria, fungi and viruses are low risk, environmentally friendly pesticides based on living microorganisms. The most studied and commonly used biological pesticide worldwide is the gram-positive, soil-dwelling bacterium Bacillus thuringiensis (Bt), an entomopathogenic microorganism. Bt is a spore-forming bacterium that produces insecticidal crystal proteins called Cry toxins during the sporulation process. These toxins are effective in killing a wide range of insect species, thus making them a good substitute for chemical insecticides because they are more ecofriendly.

However, the short persistence of Bt spores and toxins after application has become a major obstacle to its wider use for pest management. Variable environmental stresses, such as UV radiation, temperature and rain, lead to inactivation or the drifting of the crystal proteins. The half-life of bacteria spores exposed to sunlight were reported to range from 0.5 h for the bacterium and about four hours for the endotoxin. BtK remained active after 3 hours of exposure to UV, but over time a significant loss of virulence was detected toward Helicoverpa armigera larvae. To overcome the challenges of harsh environmental conditions, there is a need for new formulations which are able to protect Bt derivatives, thus improving its pest control performance under field conditions.

Numerous formulation technologies have been described and developed for biopesticides as well as for Bt. Recent advances in emulsion technologies and nanomaterials have resulted in the emergence of novel strategies to encapsulate Bt. For example, the encapsulation technologies of Bt derivatives was recently reviewed by de Oliveira et al. The main objective of encapsulation formulations for bacteria-based biopesticides is to enhance their efficiency in a cost-effective route. Bt encapsulation can involve physicochemical or mechanical processes to protect the organism, such as encapsulation in microlipidic droplets, gelation using carboxymethyl cellulose, microcapsules of amaranth starch, colloidosomal polyelectrolyte microcapsules, and a coacervation method.

Pickering emulsions, which are considered highly stable, are composed of two immiscible liquids. These emulsions can be stabilized by colloidal particles, food-grade particles, inorganic particles, or polymeric particles that spontaneously self-assemble at the oil/water interface. Pickering emulsions can come in the form of oil/water or inverse (water/oil), depending on the chemical nature of the continuous phase (dispersion) and the dispersed phase. Hydrophilic particles result in the formation of O/W emulsions and hydrophobic particles form W/O emulsions. Particles that are fully wetted by water or oil remain dispersed in that phase and cannot form an emulsion. Emulsion stability depends on the particle concentration, wettability and morphology, the oil type, as well as the volume and concentration ratios. The diameter of the droplets is dictated by the particle size and the composition of the system (o/w ratio and NP content). Pickering emulsions make it possible to tune the emulsion properties in terms of droplet diameter and the proper surface functionalization of the NPs.

The inventors postulated that the encapsulation of biopesticides (such as Bt) by means of water in oil Pickering emulsion, may have a significant potential for the development of new biopesticide formulations.

### SUMMARY OF THE INVENTION

In one aspect, there is provided a composition comprising a core-shell particle dispersed within a hydrophobic solvent, wherein: each of the core-shell particles comprises a liquid core enclosed by a shell comprising hydrophobic nanoparticles; the liquid core comprises an aqueous solution and at least one microbial cell, a spore thereof, or a combination thereof; a w/w concentration of the hydrophobic nanoparticles within the composition is between 0.1 and 10%; a w/w ratio between the aqueous solution and the hydrophobic solvent is between 5:95 and 40:60; and the hydrophobic nanoparticles comprise a chemically modified metal oxide nanoparticle.

In one embodiment, the metal oxide comprises nano clay, SiO2, TiO2, Al2O3, Fe2O3, ZnO, and ZrO or any combination thereof.

In one embodiment, the chemical modification comprises any of (C1-C20)alkyl, (C1-C20)alkyl silane group, vinyl, epoxy, a cycloalkane, an alkene, an alkyne, an ether, a silyl group, and a siloxane group, or any combination thereof.

In one embodiment, a w/w concentration of the core-shell particles within the composition is between 5% and 70%.

In one embodiment, the core-shell particle is characterized by an average size between 1 μm and 50 μm.

In one embodiment, the shell has a thickness of 10 nm to 500 nm.

In one embodiment, the core-shell particle is in a form of a sphere.

In one embodiment, the microbial cell or the spore thereof comprises a bacterium, a fungus or a combination thereof.

In one embodiment, the bacterium comprises a Bacillus specie.

In one embodiment, the Bacillus specie comprises Bacillus thuringiensis.

In one embodiment, the composition is a water in oil Pickering emulsion.

In one embodiment, the hydrophobic solvent is water immiscible and is characterized by a dipole moment of between 0 and 0.3.

In one embodiment, the hydrophobic solvent is characterized by viscosity at 25 C between 1 and 100 cP.

In one embodiment, the hydrophobic solvent is substantially non-toxic to the microbial cell or to the spore thereof; and wherein the hydrophobic solvent is substantially devoid of phytotoxicity.

In one embodiment, the hydrophobic solvent comprises a mineral oil, a C10-C30 aliphatic hydrocarbon, a fatty acid, a monoglyceride, a diglyceride, a triglyceride, a vegetable oil, wax, an essential oil, an aromatic oil, or any combination thereof.

In another aspect, there is provided a pesticide composition comprising the composition of the invention, wherein the microbial cell, the spore thereof or both is characterized by a pesticidal activity.

In one embodiment, the pesticide composition is formulated for spraying or coating.

In one embodiment, the pesticide composition comprises a pesticidal effective amount of the microbial cells, spores, or any combination thereof.

In one embodiment, the pesticidal effective amount comprises a concentration of the microbial cells, spores, or any combination thereof of at least 10% v/v.

In one embodiment, the composition of the invention or the pesticide composition of the invention, characterized by a viscosity between 103 and 105 cP.

In another aspect, there is provided an article comprising a substrate in contact with a coating comprising the pesticide composition of the invention.

In one embodiment, the coating is in a form of a coating layer.

In one embodiment, the substrate is selected from, a plant or a plant part, a polymeric substrate, a glass substrate, a metallic substrate, a fiber, a paper substrate, a brick wall, a sponge, a textile, a woven fabric, a non-woven fabric, or wood.

In one embodiment, the coating is a pesticide coating.

In one embodiment, the coating substantially retains its pesticide activity when exposed to outdoor conditions (such as a temperature −25 and 60° C., UV and/or visible light irradiation) for a time period between 1 and 30 d.

In another aspect, there is provided a method for controlling a pest, comprising applying an effective amount of the pesticide composition of the invention to at least a portion of a plant, or to an area under cultivation infested with the pest, thereby controlling or reducing growth of the pest.

In one embodiment, the pesticide composition is characterized by adhesiveness to at least a part of the plant.

In one embodiment, applying comprises any of immersion, soaking, coating, irrigating, dipping, spraying, fogging, scattering, painting, injecting, or any combination thereof.

In one embodiment, the pest is selected from an insect and an aphid.

In one embodiment, the effective amount is between 1 and 1000 L/ha.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 represents a schematic illustration representing the water-in-oil (w/o) Pickering emulsion system for Bacillus thuringiensis encapsulation.

FIGS. 2A-2C are micrographs representing confocal microscopy images of: water-in-oil Pickering emulsions stabilized by R202 hydrophobic silica with increasing oil percentages: 1 wt. % silica (2A), 2 wt. % silica (2B) and 3 wt. % silica (3C). Scale bar 20 μm.

FIGS. 3A-3C are micrographs representing confocal microscopy images of water-in-oil Pickering emulsions with a composition of 3 wt. % silica R202 and at a 30:70 water/oil ratio. The water phase was labeled with 5(6)-carboxy fluorescein (3A) and the silica by Nile Red (3B). 3C represents an overlay image. Scale bar 20 μm.

FIG. 4 represents flow curves of viscosity versus the shear rate of the exemplary water-in-oil Pickering emulsions of the invention.

FIGS. 5A-5F are micrographs representing confocal microscopy images of Beta cells labeled with SYTO 9 (green) and Propidium iodide (red) (5A). Bright field channel; (5B) and an overlay image (5C) (scale bar 10 μm); and scanning electron microscopy of Beta cell culture (5D.) Overview of BtA bacteria, spores and crystals. (5E). A single bacterium, Inset: zoom of a bacterium BtA crystals (5F). Scale bar 1 μm for 5D-E, 100 nm for 5F.

FIGS. 6A-6G represent a schematic illustration of the encapsulation process (6A); confocal microscopy images of encapsulated BtA bacteria water droplets: (6B) BtA cell labeled with SYTO 9, (6C) Bright field image, (6D) An overlay image; and cryo SEM images of encapsulated BtA cells, spore, and crystals in water droplets: (6E) BtA cell near the water droplet and inside water droplets, orange arrows point to silica nanoparticles, (6F) BtA spore inside the droplet, (6G) BtA crystal at the edge of the droplets. Scale bar; 3 μm for 6B-D and 1 μm for 6E-6G.

FIG. 7 is a graph representing dose response activity of BtA following Ricinus communis leaf impregnation against Spodoptera littoralis 1st instar larvae. Letters associated with the curves were significantly different. Univariate analysis of survival rate by days post inoculation (repeated measures) F=1500.3, DF=6, 13, P<0.0001.

FIGS. 8A1-8A4 and FIG. 8B are images representing plant leaves at the end of the insect bioassay (8A-1), plant leaves treated with water (control) (8A-2), plant leaves treated with BtA in an aqueous solution 20% v/v (8A-3), plant leaves treated with Pickering emulsion of the invention (8A-4) BtA 20% v/v in a Pickering emulsion. Photos were taken 5 days post inoculation. FIG. 8B are graphs representing survival rate of Spodoptera littoralis larvae following leaf impregnation with different treatments. Aqueous suspension (red line), 20% BtA in the aqueous suspension (pink line), inverse Pickering emulsion alone (black line) and the BtA formulation in the inverse Pickering emulsion (blue line). ANOVA F=517.51, DF=7, P<0.0001.

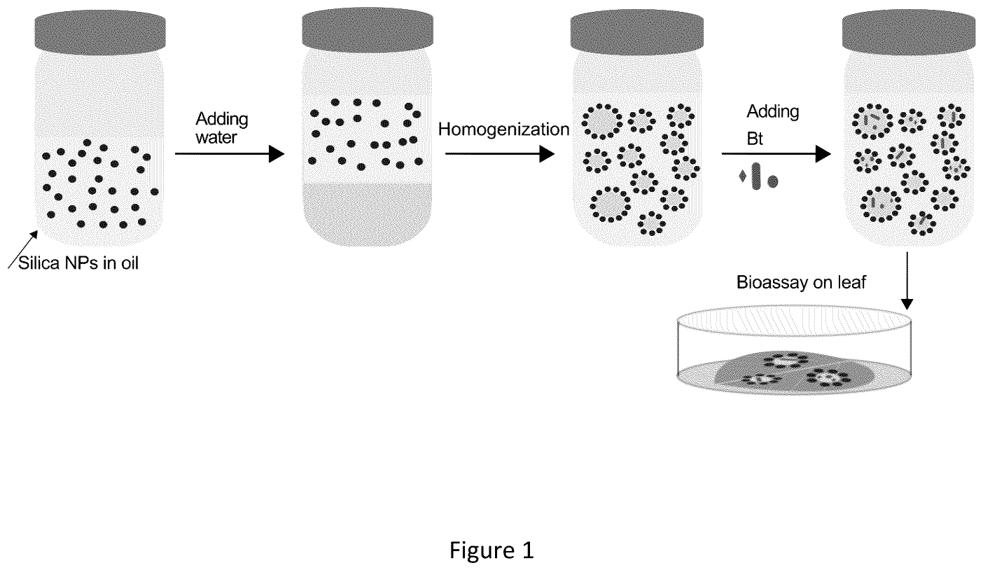

### DETAILED DESCRIPTION OF THE INVENTION

According to some embodiments, the present invention provides a composition comprising a plurality of core-shell particles. In some embodiments, the composition is a liquid composition. In some embodiments, the composition is a liquid at a temperature between 0 and 90° C. In some embodiments, the composition comprises a water-in-oil (W/O) Pickering emulsion. In some embodiments, the composition comprises an oil-in-water (O/W) Pickering emulsion. The emulsions according to the present invention comprises core-shell particles comprising a shell composed of hydrophobic nanoparticles, wherein the shell encloses a liquid core comprising an aqueous solution and at least one microbial cell, at least one a spore thereof, or a combination thereof. In some embodiments, the composition comprise the core-shell particles dispersed within a hydrophobic solvent. In some embodiments, the composition is substantially non-toxic (e.g., non-phytotoxic). In some embodiments, the microbial cell and/or a spore thereof is hydrophilic (e.g., characterized by a surface charge) and has greater affinity to the aqueous solution of the core, compared to the hydrophobic solvent.

According to one aspect of the present invention, there is provided a composition comprising a plurality of core-shell particles dispersed within a hydrophobic solvent, wherein each of the core-shell particles comprises a liquid core enclosed by a shell comprising a plurality of hydrophobic nanoparticles; the liquid core comprises an aqueous solution and at least one microbial cell, a spore thereof, or a combination thereof; a w/w concentration of the hydrophobic nanoparticles within the composition is between 0.1 and 20%; a w/w ratio between the aqueous solution and the hydrophobic solvent is between 5:95 and 40:60; and the hydrophobic nanoparticles comprise a plurality of chemically modified metal oxide nanoparticles.

In some embodiments, the shell is a single layer shell. In some embodiments, the particles are in the interface between a major phase and a minor phase, wherein the composition (e.g., emulsion or dispersion) is stabilized by the hydrophobic nanoparticles. In some embodiments, the particles are characterized by a shell encapsulating an aqueous solution comprising the microbe and/or a spore thereof.

The invention in some embodiments thereof is based on a surprising finding that water-in-oil based Pickering emulsions comprising between about 1 and about 5% w/w of hydrophobic silica, are superior for encapsulation of gram-negative bacteria and/or spores thereof (e.g., characterized by a surface charge). Furthermore, the compositions of the invention comprising encapsulated Bt spores and crystals, were characterized by an enhanced pesticidal activity under open field conditions, compared to non-encapsulated Bt crystals.

### The Composition

In one aspect of the invention, there is a composition in a form of an emulsion or dispersion. In some embodiments, the emulsion is an O/O Pickering emulsion. In some embodiments, the emulsion is a W/O Pickering emulsion. In some embodiments, the emulsion is an O/W Pickering emulsion. In some embodiments, the composition is a flowable composition (or a fluid) at a temperature between 0 and 90° C. In some embodiments, the composition is a liquid at a temperature between 0 and 90° C.

In some embodiments, the composition comprises an emulsion or dispersion, comprising a plurality of particles, wherein at least 50%, at least 60%, at least 70%, at least 80%, at least 90%, at least 95%, at least 97%, at least 99% of the particles within the composition encapsulate at least one microbial cell, a spore thereof, or a combination thereof. In some embodiments, the particles are in the form of droplets. In some embodiments, the particles are in the form of core-shell particles (e.g., each particle comprises a shell and a core).

As used herein, the term “Pickering emulsion” refers to an emulsion that utilizes solid particles as a stabilizer to stabilize droplets of a substance, in a dispersed phase in the form of droplets dispersed throughout a continuous phase.

As used herein, the term “emulsion” refers to a combination of at least two fluids, where one of the fluids is present in the form of droplets in the other fluid. The term “emulsion” includes microemulsions.

As used herein, the term “fluid” refers to a substance that tends to flow and to conform to the outline of its container, i.e., a liquid, a gas, a viscoelastic fluid, etc. Typically, fluids are materials that are unable to withstand a static shear stress, and when a shear stress is applied, the fluid experiences a continuing and permanent distortion. The fluid may have any suitable viscosity that permits flow. In some embodiments, fluid is characterized by a viscosity sufficient for application thereof (e.g., to a plant or a plant part and/or to an area under cultivation), such as by spraying or fumigation. If two or more fluids are present, each fluid may be independently selected among essentially any fluids (liquids, gases, and the like) by those of ordinary skill in the art, by considering the relationship between the fluids. In some cases, the droplets may be contained within a carrier fluid, e.g., a liquid.

According to one aspect of the present invention, there is provided a fluid (e.g. liquid) composition comprising core-shell particles dispersed within a hydrophobic solvent, wherein each of the core-shell particles comprises a liquid core enclosed by a shell comprising hydrophobic nanoparticles; the liquid core comprises an aqueous solution and at least one microbial cell, a spore thereof, or a combination thereof; a w/w concentration of the hydrophobic nanoparticles within the composition is between 0.1 and 20%; a w/w ratio between the aqueous solution and the hydrophobic solvent is between 5:95 and 40:60; and the hydrophobic nanoparticles comprise a chemically modified metal oxide nanoparticle. In some embodiments, each core of the core-shell particles within the composition of the invention encapsulates a single microbial cell, and/or a single spore thereof. In some embodiments, the particle size corresponds with the size of a microbe. In some embodiments, the particle size is so as to encapsulate a single microbial cell. In some embodiments, each core of the core-shell particles within the composition of the invention encapsulates a plurality of microbial spores.

Th term “metal oxide” when used in conjunction with a nanoparticle, encompasses both metal oxide(s) and metalloid oxide(s). Metalloids are known in the art including inert alia Si, B, Ge, As, etc.

In some embodiments, the composition of the invention comprises a hydrophobic solvent (also referred to herein as “major phase”) and a plurality of the core-shell particles of the invention dispersed therewithin.

In some embodiments, the major phase comprises a hydrophobic solvent immiscible with water. In some embodiments, the hydrophobic solvent is substantially devoid of a polar organic solvent. In some embodiments, the hydrophobic solvent is substantially devoid of a halogenated solvent. In some embodiments, the hydrophobic solvent is substantially devoid of an aromatic solvent.

In some embodiments, the hydrophobic solvent is substantially non-polar. In some embodiments, the hydrophobic solvent is water immiscible. In some embodiments, the hydrophobic solvent is characterized by water solubility of less than 1 g/100 L, less than 0.1 g/100 L, less than 0.1 g/100 L, less than 0.001 g/100 L, including any range therebetween.

In some embodiments, the hydrophobic solvent is characterized by water solubility of between 0.0001 and 0.1 g/100 L, between 0.0001 and 0.001 g/100 L, between 0.001 and 0.005 g/100 L, between 0.005 and 0.01 g/100 L, between 0.01 and 0.05 g/100 L, between 0.05 and 0.1 g/100 L, including any range therebetween.

In some embodiments, the hydrophobic solvent is characterized by a dipole moment of less than 0.4, less than 0.2, less than 0.1, including any range therebetween.

In some embodiments, the hydrophobic solvent is characterized by a dipole moment of between 0 and 0.3, between 0 and 0.5, between 0 and 0.01, between 0.01 and 0.05, between 0.05 and 0.1, between 0.1 and 0.3, between 0.1 and 0.2, between 0.2 and 0.3, between 0.3 and 0.5, including any range therebetween.

In some embodiments, the hydrophobic solvent is water immiscible solvent characterized by a dipole moment as described hereinabove.

In some embodiments, the hydrophobic solvent is compatible with the microbial cell and/or a spore thereof. In some embodiments, the term “compatible” as used herein, refers to the solvent which doesn't substantially affects viability of the microbial cells and/or microbial spores. In some embodiments, the term “compatible” as used herein, refers to the solvent which doesn't substantially affects viability of a plant. In some embodiments, the solvent is referred to as compatible when it reduces viability of not more than 20%, not more than 15%, not more than 10%, not more than 5%, not more than 1% of the initial microbial cell or spore population, wherein the viability reduction is upon exposure of microbes to the solvent for a time period of less than 20 min, less than 15 min, less than 10 min, less than 1 min including any range between. In some embodiments, the microbial cells and/or a spores thereof are compatible with the hydrophobic solvent when exposed thereto at the processing conditions disclosed herein. In some embodiments, the hydrophobic solvent is referred to as compatible when it is substantially non-toxic to the microbe, include a spore thereof, and/or substantially non-toxic to a plant.

In some embodiments, the hydrophobic solvent is characterized by a high boiling point of at least 80° C., at least 90° C., at least 100° C., at least 120° C., at least 150° C., at least 170° C., including any range between.

In some embodiments, the hydrophobic solvent is characterized by viscosity at 25° C. of between 1 and 100 cP, between 1 and 5 cP, between 5 and 10 cP, between 10 and 15 cP, between 15 and 20 cP, between 20 and 100 cP, between 10 and 100 cP, between 10 and 50 cP, between 50 and 100 cP, between 15 and 30 cP, between 15 and 50 cP, between 20 and 50 cP, between 10 and 30 cP, between 10 and 40 cP, between 10 and 60 cP, between 10 and 70 cP, between 10 and 80 cP, including any range between.

In some embodiments, the hydrophobic solvent comprises a mineral oil, a C10-C30 aliphatic hydrocarbon, a fatty acid, a monoglyceride, a diglyceride, a triglyceride, a vegetable oil, a wax, an essential oil, an aromatic oil, or any combination thereof.

In some embodiments, the hydrophobic solvent is or comprises an oil. In embodiments, the oil is selected from the group consisting of essential oils, vegetable oils, mineral oils, organic oils, lipids, and any water-immiscible liquids.

As used herein, the term “mineral oil” refers to an oil obtained from a mineral source. In some embodiments, mineral oil refers to a liquid by-product of refining crude oil to make gasoline and other petroleum products. A mineral oil is any of various colorless, odorless, light mixtures of alkanes in the range of C-10 to C-40 or of C-15 to C-40. Mineral oil is available in light and heavy grades. In some embodiments mineral oil refers to a raw and/or purified distillate fraction obtained from a mineral source. In some embodiments, the mineral oil is chemically modified. Mineral oils are well known in the art and are used herein in the same manner as they are commonly used in the art. Such oils are readily available from commercial chemicals suppliers throughout the world. Methods for preparation of mineral oils are well known in the art.

In some embodiments, the hydrophobic solvent is or comprises a C10-40, C10-20, C10-30, C10-15, C15-30, C15-40, C15-20, C20-30, C20-40 hydrocarbon chain, including any range between.

Non-limiting examples of a suitable oil according to the present invention include mineral oil, paraffinic oil (based on n-alkanes), naphthenic oil (based on cycloalkanes), hydrocarbon oil (based on hydrocarbons), a fatty acid (including a short-chain fatty acid and/or a long chain fatty acid) and/or any ester thereof, a vegetable oil (oil comprising fatty acids and/or esters thereof extracted from seeds, or other plant parts), wax, essential oil (based on extracts from plants), and aromatic oil (based on aromatic hydrocarbons and distinct from essential oils). Such oils are well known in the art.

In some embodiments, the hydrophobic solvent is or comprises a single solvent specie. In some embodiments, the fluid consists essentially of the hydrophobic solvent. In some embodiments, the hydrophobic solvent refers to any known hydrophobic solvent being utilized in a chemical and/or pharmaceutical industry. In some embodiments, the hydrophobic solvent is substantially devoid of an additional liquid. In some embodiments, the hydrophobic solvent comprises a plurality of chemically distinct hydrophobic solvents (e.g., a mixture of solvents).

In some embodiments, the hydrophobic solvent is selected from an aromatic hydrocarbon, an aliphatic hydrocarbon or both.

Non-limiting examples of aliphatic hydrocarbon include but are not limited to: pentane, hexane, cyclohexane, octane, heptane, or any combination thereof. Other aliphatic hydrocarbon solvents are well known in the art such as ethyl ether, methyl ethyl ketone (MEK), methyl isobutyl ketone, dichloromethane, chloroform, aliphatic esters (such as ethyl acetate).

Non-limiting examples of hydrophobic solvents (e.g., aromatic hydrocarbons) include but are not limited to: toluene, ethylbenzene, xylene, chlorobenzene, styrene, dichlorobenzene, nitrobenzene, trimethylbenzene, trichlorobenzene or any combination thereof. In some embodiments, the composition of the invention is substantially devoid of chlorinated solvents, fluorinated solvents, or both. In some embodiments, the hydrophobic solvent is substantially devoid of hydrocarbon solvents having hydrocarbon chains of less than C-10, less than C-9, less than C-8 including any range between.

In some embodiments, the core-shell particle of the invention comprises an aqueous core and an amphiphilic shell. In some embodiments, the core-shell particle is in a form of a colloidosome.

In some embodiments, the core-shell particle has a substantially spherical geometry or shape. In some embodiments, a plurality of core-shell particles is devoid of any characteristic geometry or shape. In some embodiments, the core-shell particle has a spherical shape, a quasi-spherical shape, a quasi-elliptical sphere, a concave shape, an irregular shape, or any combination thereof. One skilled in the art will appreciate that the exact shape of each of the plurality of core-shell particles may differ from one particle to another. Moreover, the exact shape of the core-shell particle may be derived from any of the geometric forms listed above, so that the shape of the particle does not perfectly fits to a specific geometrical form. One skilled in the art will appreciate that the exact shape of the core-shell particle may have substantial deviations (such as at least 5%, at least 10%, at least 20% deviation) from a specific geometrical shape (e.g., a sphere or an ellipse).

In some embodiments, the core-shell particle is characterized by a particle size compatible with the microbial cell, and/or a spore thereof, encapsulated within the core. In some embodiments, the particle size is predetermined so as to include one or more microbial cells, and/or a spores thereof within each of the core-shell particles disclosed herein. In some embodiments, the particle size is predetermined by the chemical composition of the composition of the invention (such as a ratio between the aqueous solution and the hydrophobic solvent, concentration of the hydrophobic nanoparticles, etc.).

In some embodiments, the particle size of the core-shell particles is between 0.5 μm and 500 μm, 1 μm to 100 μm, 1 μm to 50 μm, 10 μm to 50 μm, 1 μm to 10 μm, 10 μm to 50 μm, 10 μm to 20 μm, 20 μm to 50 μm, 20 μm to 30 μm, 30 μm to 50 μm, 50 μm to 80 μm, 1 μm to 20 μm, 1 μm to 30 μm, 1 μm to 40 μm, 1 μm to 5 μm, 1 μm to 8 μm, 5 μm to 10 μm, 5 μm to 50 μm, 5 μm to 20 μm, 5 μm to 30 μm, including any range or value therebetween.

In some embodiments, the diameter of the particle size described herein, represents an average particle size. In some embodiments, the size of the core-shell particle described herein represents an average size (e.g., arithmetic mean) of the plurality of particles within the composition of the invention.

In some embodiments, the average particle size refers to the size of at least 50%, 60%, 70%, 80%, 90%, 95% or 99% of the particles including any range between. In some embodiments, the average particle size ranges from: 5 μm to 50 μm, 1 μm to 50 μm, 5 μm to 10 μm, including any range therebetween. In some embodiments, the diameter of the core-shell particle described herein, is a wet diameter (i.e., a diameter of particles within a liquid composition, as measured based on common particle size measurement techniques, such as microscopic examination, DLS or other methods known in the art). In some embodiments, a plurality of the core-shell particles has a uniform size. By “uniform” or “homogenous” it is meant to refer to size distribution that varies within a range of less than e.g., ±60%, ±50%, ±40%, ±30%, ±20%, or ±10%, including any value therebetween.

In some embodiments, the core-shell particle is in a form of a droplet.

As used herein, the term “droplet” refers to an isolated portion of a first fluid that is surrounded by a second fluid. It is to be noted that a droplet is not necessarily spherical; but may assume other shapes as well, for example, depending on the external environment. The fluidic droplets may have any shape and/or size. Typically, monodisperse droplets are of substantially the same size. In some embodiments, the average particle size of the droplet refers to the cross-section dimension (e.g., diameter) of the droplet. In some embodiments, the cross-section dimension refers to the largest distance between two points at the outer portion of the particle's shell. The average particle size of a single droplet, in a non-spherical droplet, is the diameter of a perfect sphere having the same volume as the non-spherical droplet.

In some embodiments, the core-shell particle comprises between 0.1% and 20%, between 0.1% and 0.5%, between 0.5% and 1%, between 1% and 1.5%, between 1.5% and 2%, between 2% and 3%, between 3% and 5%, between 5% and 10%, between 10% and 20% (w/w) of the hydrophobic nanoparticles including any range therebetween, by weight of the core-shell particle.

In some embodiments, the shell is in a form of a layer. In some embodiments, the shell is in a form of a uniform layer. In some embodiments, the shell is in a form of a homogenous layer. In some embodiments, the hydrophobic nanoparticles are homogenously distributed within the entire volume of the shell.

In some embodiments, the shell comprises an inner portion facing the core (e.g., particle's core) and an outer portion facing the hydrophobic solvent. In some embodiments, the shell forms an interphase layer between the hydrophilic (e.g., aqueous) core and the hydrophobic solvent (e.g., major phase). In some embodiments, the composition is a w/o emulsion, wherein the aqueous minor phase forms a core, and the interphase forms a shell of the core-shell particle of the invention.

In some embodiments, the shell stabilizes the core. In some embodiments, the shell encapsulates the core.

In some embodiments, the shell has a thickness in the range of 5 nm to 50 nm, 15 nm to 50 nm, 30 nm to 50 nm, 1 nm to 50 nm, 2 nm to 50 nm, 5 μm to 10 nm, 10 nm to 50 nm, 5 nm to 30 nm, 15 nm to 30 nm, 1 nm to 20 nm, 2 nm to 20 nm, 5 nm to 20 nm, or 10 nm to 20 nm, 20 nm to 30 nm, 30 nm to 40 nm, 40 nm to 80 nm, 80 nm to 100 nm, 100 nm to 200 nm, 200 nm to 300 nm, 300 nm to 500 nm, including any range therebetween. In some embodiments, the shell thickness is quantified using scanning electron microscopy (SEM).

In some embodiments, the nanoparticles are hydrophobic. In some embodiments, the outer surface of the nanoparticles is hydrophobic. In some embodiments, the nanoparticles comprise inorganic particles. In some embodiments, the hydrophobic nanoparticles comprise chemically modified inorganic particles. In some embodiments, the hydrophobic nanoparticles comprise inorganic particles having a chemical modification (e.g., a hydrophobic group attached thereto).

In some embodiments, the hydrophobic nanoparticle comprises a metal (or metalloid) oxide. In some embodiments, the hydrophobic nanoparticles comprise a metal oxide as a core and a hydrophobic coating or shell bound thereto. In some embodiments, the hydrophobic nanoparticles are metal oxide-based particles. In some embodiments, the hydrophobic nanoparticles are selected from the group consisting of silica, titanium oxide, clay, and any combination thereof. In some embodiments, the hydrophobic nanoparticles are chemically identical particles, or comprise two or more chemically distinct particles.

In some embodiments, the one or more hydrophobic nanoparticle as disclosed herein, comprises alkyl-functionalized, silane-functionalized, alkoxy silane-functionalized, alkyl silane-functionalized metal oxide nanoparticle, or any combination thereof. In some embodiments, functionalized comprises a chemical moiety covalently bound to the metal oxide nanoparticle. In some embodiments, the chemical moiety comprises any of (C1-C20) alkyl, (C1-C20) alkyl silane group, vinyl, epoxy, a cycloalkane, an alkene, an alkyne, an ether, a silyl group, and a siloxane group, or any combination thereof. In some embodiments, the hydrophobic nanoparticle is substantially devoid of halogen atoms. In some embodiments, the chemical moiety is substantially devoid of a halo group (such as fluoro and/or chloro moieties). In some embodiments, the non-halogenated hydrophobic nanoparticle is substantially devoid of a halo-alkyl moiety. In some embodiments, the non-halogenated hydrophobic nanoparticle is substantially devoid of a halo-alkyl silane moiety. In some embodiments, the hydrophobic nanoparticle is devoid of fluorinated metal oxide nanoparticles.

In some embodiments, the hydrophobic coating comprises an alkyl silane group. In some embodiments, the alkyl silane group comprises between 1 and 20, between 1 and 3, between 3 and 5, between 5 and 7, between 7 and 10, between 10 and 15, between 15 and 20 carbon atoms, including any range between. In some embodiments, the alkyl group comprises between 1 and 20, between 1 and 3, between 3 and 5, between 5 and 7, between 7 and 10, between 10 and 15, between 15 and 20 carbon atoms, including any range between.

In some embodiments, the hydrophobic nanoparticles comprise a metal (and/or metalloid) oxide as a core and a hydrophobic coating or shell bound thereto, wherein the hydrophobic coating comprises an alkyl silane group comprising between 1 and carbon atoms. In some embodiments, the hydrophobic nanoparticles comprise a metal oxide as a core and a hydrophobic coating or shell bound thereto, wherein the hydrophobic coating comprises a methyl silane group attached to the metal oxide (e.g., to the oxygen atom). In some embodiments, the hydrophobic nanoparticle comprises a metal oxide, wherein at least a part of the metal oxide (e.g., oxygen atom) is covalently bound to an alkyl silane group (e.g., methyl silane, such as dimethyl silyl group). In some embodiments, the hydrophobic nanoparticle comprises a chemically modified (e.g., silylated) metal oxide (such as silica). In some embodiments, the hydrophobic nanoparticles comprise metal oxide (such as silica) modified (e.g., via a covalent binding) with polydimethylsiloxane (PDMS).

In some embodiments, the hydrophobic coating comprises any of (C1-C20)alkyl, (C1-C20)alkyl silane group, vinyl, epoxy, a cycloalkane, an alkene, an alkyne, an ether, a silyl group, and a siloxane group, or any combination thereof. In some embodiments, the hydrophobic coating consists essentially of an alkyl silane group, as described herein.

Non-limiting examples of silane-hydrophobic nanoparticles include silane, methyl silane, linear alkyl silane (e.g., methyl silane), branched alkyl silane, aromatic silane, and dialkyl silane (e.g., dimethyl silane).

The term “silica” as used here refers to a structure containing at least the following the elements: silicon and oxygen. Silica may have the fundamental formula of SiO₂ or it may have another structure including SiₓO_{y} (where x and y can each independently be about 1 to 10). Additional elements including, but not limited to, carbon, nitrogen, sulfur, phosphorus, or ruthenium may also be used. Silica may be a solid particle, or it may have pores.

In some embodiments, the metal oxide comprises nano clay, SiO₂, TiO₂, Al₂O₃, Fe₂O₃, ZnO, and ZrO or any combination thereof.

In some embodiments, the hydrophobic nanoparticles are characterized by an average (e.g., arithmetic mean) particle size of 1 nm to 900 nm. In some embodiments, the average particle size of the hydrophobic nanoparticles is between 2 nm to 600 nm, 2 nm to 550 nm, 2 nm to 520 nm, 2 nm to 500 nm, 2 nm to 480 nm, 2 nm to 450 nm, 2 nm to 400 nm, 2 nm to 350 nm, 2 nm to 300 nm, 2 nm to 250 nm, 2 nm to 200 nm, 2 nm to 150 nm, 2 nm to 100 nm, 5 nm to 600 nm, 10 nm to 600 nm, 15 nm to 600 nm, 20 nm to 600 nm, 40 nm to 600 nm, 50 nm to 600 nm, 100 nm to 600 nm, 5 nm to 500 nm, 10 nm to 500 nm, 15 nm to 500 nm, 20 nm to 500 nm, 40 nm to 600 nm, 50 nm to 500 nm, 100 nm to 500 nm, 5 nm to 400 nm, 10 nm to 400 nm, 15 nm to 400 nm, 20 nm to 400 nm, 40 nm to 400 nm, 50 nm to 400 nm, 100 nm to 400 nm, 5 nm to 50 nm, 5 nm to 40 nm, 2 nm to 50 nm, 2 nm to 10 nm, 2 nm to 20 nm, or 2 nm to 40 nm, including any range therebetween. In some embodiments, the size of at least 90% of the nanoparticles varies within a range of less than ±25%, ±20%, ±15%, ±19%, ±5%, including any value therebetween.

Herein throughout, the terms “nanoparticle”, “nano”, “nanosized”, and any grammatical derivative thereof, which are used herein interchangeably, describe a particle featuring a size of at least one dimension thereof (e.g., diameter, length) that ranges from about 1 nanometer to 100 nanometers. Herein throughout, “NP(s)” designates nanoparticle(s).

In some embodiments, the term “average” particle size refers to the physical diameter (also termed “dry diameter”) of the hydrophobic nanoparticles. In some embodiments, the dry diameter of the hydrophobic particles, according to some embodiments of the invention, may be evaluated using transmission electron microscopy (TEM) or scanning electron microscopy (SEM) imaging.

Non-limiting example of the hydrophobic particle of the invention is hydrophobic fumed silica, such as AEROSIL® R 202.

The hydrophobic particle(s) can be generally shaped as a sphere, incomplete sphere, particularly the size attached to the substrate, a rod, a cylinder, a ribbon, a sponge, and any other shape, or can be in a form of a cluster of any of these shapes, or a mixture of one or more shapes. In some embodiments, the hydrophobic particle has a spherical shape, a quasi-spherical shape, a quasi-elliptical sphere, an irregular shape, or any combination thereof.

In some embodiments, the hydrophobic particles are in the interface between a major phase and a minor phase. In some embodiments, the major phase is a continuous phase. In some embodiments, a minor phase is a dispersed phase. In some embodiments, the hydrophobic particles are in the interface of the major phase (e.g., the hydrophobic solvent described herein) and the core (e.g., aqueous core) of the core-shell particle described herein (e.g., colloidosome).

In some embodiments, a w/w concentration of the hydrophobic nanoparticles within the composition is between 0.5 and 10%, between 0.5 and 5%, between 0.8 and 10%,

between 0.8 and 5%, between 0.9 and 10%, between 0.9 and 5%, between about 1 and 10%, between about 1 and 5%, between about 1 and 3%, between about 3 and 10%, between about 3 and 5%, between 5 and 10%, including any range between. In some embodiments, a w/w concentration of the hydrophobic nanoparticles affects the viscosity of the composition. In some embodiments, a w/w concentration of the hydrophobic nanoparticles predetermines the viscosity of the composition, and further predetermines the particle size of the core-shell particle of the invention. Accordingly, the concentration of the hydrophobic nanoparticles within the composition of the invention is so as to obtain (i) a composition characterized by viscosity appropriate for application to the plant and/or area under cultivation (e.g. by spraying, coating, fumigating, etc.), as described herein; and/or (ii) a composition characterized by a particle size of the core-shell particles suitable for encapsulation of at least one microbial cell, and/or a spore thereof.

In some embodiments, a w/w ratio between the aqueous solution and the hydrophobic solvent within the composition is between 5:95 and 40:60, between 5:95 and 10:90, between 10:90 and 40:60, between 10:90 and 20:80, between 20:80 and 40:60, between 20:80 and 30:70, between 30:70 and 40:60, including any range between.

In some embodiments, a w/w ratio between the aqueous solution and the hydrophobic solvent predetermines the stability of the composition. In some embodiments, a composition of the invention comprising a w/w ratio between the aqueous solution and the hydrophobic solvent as described herein is stable (e.g., devoid of phase separation, etc.) for a time period descried herein.

In some embodiments, the composition is a stable liquid composition. In some embodiments, the liquid composition is stable for at least 6 hours (h), at least 12 h, at least 24 h, at least 48 h, at least 72 h, at least 96 h, at least 10 days (d), at least one month (m), at least 6 m, at least 12 m % including any range therebetween.

As used herein the term “stable”, refers to the ability of the liquid composition to maintain substantially its intactness, such as being substantially devoid of aggregation, precipitation and/or phase separation. In some embodiments, a stable composition (e.g., the composition or the liquid composition of the invention) is substantially devoid of aggregates. In some embodiments, aggregates comprising a plurality of cores-shell particles adhered or bound to each other. in some embodiments, a stable composition is substantially devoid of free (e.g., non-encapsulated) microbes or spores thereof. In some embodiments, the composition of the invention is referred to as stable when at least 70%, at least 80%, at least 85%, at least 90%, at least 95%, at least 97% including any range between, of the initial microbe loading remains encapsulated within the core-shell particle under suitable storage conditions and for a time period described herein. In some embodiments, the composition of the invention is referred to as stable, when at least 70%, at least 80%, at least 85%, at least 90%, at least 95%, at least 97% including any range between, of the initial microbe loading remains viable upon storage thereof under suitable storage conditions.

In some embodiments, composition of the invention is an agricultural composition. In some embodiments, the composition of the invention is formulated for application thereof to an area under cultivation (e.g., to a plant or a plant part and/or to a soil) infested with a pest. In some embodiments, the composition of the invention is characterized by a viscosity sufficient for application thereof to the area under cultivation (e.g., to a plant or a plant part and/or to a soil) infested with a pest, such as by spraying, coating or fumigation. In some embodiments, the composition of the invention is characterized by a viscosity suitable for coating a part of a plant. In some embodiments, the composition of the invention is characterized by a viscosity suitable for obtaining a coating layer on top of the plant and/or a part thereof. In some embodiments, the coating layer is so as to maintain biological activity of the plant (e.g., respiration).

In some embodiments, the composition of the invention (e.g., an agricultural, and/or a pesticidal composition) is characterized by substantial retention time on top of the plant and/or a prat thereof. In some embodiments, the retention time is sufficient for maintaining at least 30%, at least 50%, at least 70%, at least 90% of the initial pesticidal activity of the composition (referred to the activity at the day of application), including any range between. In some embodiments, the retention time is at least 1 day(d), at least 2 d, at least 5 d, at least 7 d, at least 10 d, at least 15 d, at least 30 d, including any range between. In some embodiments, the composition of the invention remains stably bound (physically stable) or in contact with the plant, and/or with a part of the plant when exposed to ambient conditions at the area under cultivation (e.g., exposure to UV light, rain, moisture, temperatures of between 0 and 50° C., etc.).

In some embodiments, a coating layer comprising the composition and/or the pesticidal composition in contact with or adhered to a plant and/or a part thereof, is stable to climatic changes. In some embodiments, a coating layer substantially prevents environmental damage (e.g., due to ambient conditions such as temperature changes, heat, cold, UV radiation and atmospheric gases) to the microbe and/or to the spore thereof. In some embodiments, a coating layer substantially preserves pesticidal activity of the microbe and/or to the spore thereof upon exposure to environmental damage for a time period describe herein. In some embodiments, the coating layer is stable to temperature changes, heat, cold, UV radiation and atmospheric gases. In some embodiments, the pesticidal properties and/or stability of the coating layer are not affected or altered by climatic changes as described herein.

In some embodiments, the composition of the invention (e.g., an agricultural, and/or a pesticidal composition) is characterized by a viscosity of between 10² and 10⁵ cP, between 10² and 10⁴ cP, between 10² and 10¹ cP, between 10¹ and 10⁴ cP, between 10⁴ and 10⁵ cP, including any range between.

In some embodiments, the viscosity of the composition is sufficient for stabilizing thereof, thereby resulting in a composition characterized by stability for at least 1 month (m), at least 2 m, at least 6 m, at least 10 m, at least 12 m, at least 24 m, at least 36 m, including any range between.

In some embodiments, stability of the composition is referred to a prolonged storage thereof under suitable storage conditions comprising inter alia: ambient atmosphere and a temperature of less than 30° C., less than 20° C., less than 15° C., less than 10° C., less than 5° C., less than 2° C., less than 0° C., including any range between. In some embodiments, the suitable storage conditions comprise a low storage temperature sufficient for substantially preventing germination of microbial spores. In some embodiments, the term “stable” is as described herein.

### Core

In some embodiments, the core of the core shell particle of the invention (e.g., droplet) comprises between 20% and 90%, between 20% and 50%, between 20% and 30%, between 30% and 50%, between 50% and 70%, between 70% and 90%, between 90% and 99% (w/w) of an aqueous solution, including any range therebetween.

In some embodiments, the particle core further comprises between 0.1% and 50%, between 0.1% and 5%, between 5% and 10%, between 10% and 20%, between 20% and 30%, between 30% and 50%, between 50% and 70%, between 10% and 90%, between 70% and 90% (w/w) of at least one microbial cell and/or a spore thereof.

In some embodiments, the microbial cell and/or a spore thereof is viable. In some embodiments, the microbial cell and/or a spore thereof is viable within the composition of the invention, and/or the microbial cell and/or a spore thereof is viable upon application of the composition of the invention to the plant/plant part; and/or to the area under cultivation. As used herein, the term “viable” encompasses being capable of: replicating a genome or DNA, cell proliferation or replication, RNA synthesis, protein translation, fermentation or any equivalent energy production process, secretion of active compounds, such as disclosed herein (e.g., Cry toxins), or any combination thereof.

In some embodiments, the microbial spore comprises a spore and/or a crystal thereof. In some embodiments, the microbial spore comprises Bacillus thuringiensis crystal.

In some embodiments, the microbial cell and/or a spore thereof is or comprises a biopesticide. In some embodiments, the microbial cell and/or a spore thereof is characterized by a pesticidal activity. In some embodiments, the microbial cell and/or a spore thereof is capable of reducing or controlling growth (e.g., activity, propagation etc.) of a pest. In some embodiments, the microbial cell and/or a spore thereof is capable of reducing or controlling infestation of the plant and/or area under cultivation (e.g., infested by the pest). In some embodiments, the microbial cell and/or a spore thereof is capable of preventing plant and/or soil infestation by the pest. In some embodiments, the microbial cell and/or a spore thereof is characterized by toxicity to the pest. In some embodiments, the microbial cell and/or a spore thereof is capable of reducing activity or loading of the pest, wherein the activity and/or loading refers to a plant (or a plant part), an area under cultivation (e.g., soil, forest, planting area, orchard, etc.), and/or a waterbody. In some embodiments, the microbial cell and/or a spore thereof comprises a toxin capable of killing the pest. In some embodiments, the plant part is selected from stem, a leave, inflorescence, a root, a fruit, a seed or any combination thereof.

In some embodiments, the microbial cell and/or a spore thereof comprises a microbe selected from a bacterium, a fungus or a combination thereof. In some embodiments, the bacterium comprises a Bacillus specie. In some embodiments, the Bacillus specie comprises Bacillus thuringiensis.

In some embodiments, the pest is or comprises a pathogen, such as a plant pathogen, a soil pathogen or both. In some embodiments, the pathogen is a mosquito. In some embodiments, the pathogen is a tree pathogen. In some embodiments, the pathogen is a mosquito. In some embodiments, the pathogen is a forest pathogen (such as a plant pathogen selected from an aphid, a nematode, a wireworm, an insect, or a combination thereof). In some embodiments, the pathogen is selected from an aphid, a nematode, a wireworm, an insect, a fungus, and a microorganism or any combination thereof. Non-limiting examples of pathogens comprise, but are not limited to: Helicoverpa armigera, Spodoptera littoralis, Myzus persicae, Aphis gossypii, Brevicoryne brassicae, Aphis nerii, Bemisia tabaci and Rhopalosiphum maidis or any combination thereof.

### Pesticide Compositions

In some embodiments, the composition of the invention is a liquid composition. In some embodiments, the composition of the invention is in a form of an emulsion (W/O emulsion), a dispersion, a suspension, and a micro emulsion or any combination thereof. In some embodiments, the composition is in a form of a Pickering emulsion, as described herein. In some embodiments, the composition comprises a water-in-oil (W/O) Pickering emulsion.

In some embodiments, the composition of the invention is a pesticide composition. In some embodiments, the pesticide composition is in a form of water in oil emulsion, and/or water in oil Pickering emulsion, comprising a microbe or a spore thereof encapsulated within the aqueous core the core-shell particle of the invention (e.g., in a form of a droplet). In some embodiments, the composition of the invention is characterized by a prolonged pesticidal activity and/or prolonged residence time on a plant (or a part thereof) and/or within the area under cultivation, as compared to a non-encapsulated microbe or a spore thereof, wherein prolonged is by at least 1 d, at least 5 d, at least 10 d, at least 15 d, at least 20 d, at least 30 d, including any range between. In some embodiments, the composition of the invention substantially prevents damage to the microbe or a spore thereof for a time period between 1 d and 60 d, between 1 d and 10 d, between 1 d and 5 d, between 10 d and 20 d, between 20 d and 30 d, between 30 d and 40 d, between 40 d and 60 d, including any range between.

In some embodiments, the pesticide composition comprises an agriculturally acceptable carrier. In some embodiments, the hydrophobic solvent of the pesticide composition is an agriculturally acceptable solvent.

In some embodiments, the pesticide composition of the invention comprises a pesticide effective number of microbial cells, microbial spores, or any combination thereof, wherein the microbes and/or spores thereof are characterized by a pesticide activity as described herein. In some embodiments, the pesticidal effective amount is sufficient for reducing plant damage associated with the pest, reducing growth and/or reducing pest loading on a plant or within the area under cultivation, wherein reducing comprises any statistically significant reduction, such as by at least 5%, at least 10%, at least 15%, at least 20%, at least 25%, at least 30%, at least 40%, at least 50%, at least 60%, including any range therebetween.

In some embodiments, the pesticide effective amount comprises a concentration of the microbial cells, and/or microbial spores within the pesticide composition of the invention of at least 5%, at least 10%, at least 15%, at least 20%, at least 25%, at least 30%, at least 40% v/v, including any range therebetween. In some embodiments, the pesticide effective amount comprises a concentration of the microbial cells, and/or microbial spores within the pesticide composition of the invention of between 10 and 90%, between 10 and 80%, between 10 and 70%, between 10 and 60%, between 10 and 50%, between 20 and 90%, between 20 and 70%, between 20 and 50%, between 10 and 20%, between 10 and 30%, between 30 and 90%, between 30 and 70%, between 30 and 50% v/v, including any range therebetween.

In some embodiments, the pesticide composition of the invention is a liquid composition formulated for application on an infested plant or a part thereof or to an infested area under cultivation such as infested soil. In some embodiments, the plant and/or the soil is infested with a pest such as a plant pathogen, soil pathogen or both. In some embodiments, the pesticide composition of the invention is formulated (e.g., characterized by a suitable viscosity, as described herein) for application by any of spraying, fogging, fumigation, and coating including any combination thereof.

In some embodiments, the pesticide composition is for use as: a UV protective coating, an anti-fungal composition, an anti-microbial composition, an anti-insect composition, an anti-viral composition, an anti-mold composition, a plant protective composition, or any combination thereof.

### The Article

According to some embodiments, the present invention provides an article comprising a substrate in contact with the composition of the invention, or in contact with the core-shell particles of the invention. In some embodiments, the core-shell particles are bound to the substrate. In some embodiments, the core-shell particles are mixed with the substrate. In some embodiments, the core-shell particles are in a form of a coating layer on the substrate. In some embodiments, the coating layer is substantially homogeneous layer. In some embodiments, the coating layer is homogenously distributed on at least a portion of the substrate.

In some embodiments, the coating layer is characterized by an average thickness of between 1 and 100 um, between 1 and 10 um, between 10 and 20 um, between 2 and 50 um, between 50 and 100 μm, including any range between.

According to some embodiments, the present invention provides an article comprising the liquid composition of the present invention. In some embodiments, the article comprises the liquid composition (e.g., water in oil emulsion) within a package. In some embodiments, the package is or comprises a container suitable for holding a liquid volume.

In some embodiments, the substrate is selected from a plant or a plant part (e.g., a leave, a stem, a fruit, etc.), soil, a polymeric substrate, glass substrate, a metallic substrate, a paper substrate, a carton substrate, a polystyrene substrate, a tissue-based substrate, a brick wall, a sponge, a textile, a non-woven fabric, or wood. In some embodiments, the substrate is or comprises an edible matter.

In some embodiments, the article or the coating layer is stable. In some embodiments, the coating layer is characterized by an average thickness of 100 nm to 500 μm, 100 nm to 400 μm, 100 nm to 300 nm, 300 nm to 500 nm, 500 nm to 1000 nm, 250 nm to 400 μm, 500 nm to 400 μm, 900 nm to 400 μm, 1 μm to 400 μm, 10 μm to 400 μm, 50 μm to 400 μm, 100 μm to 400 μm, 250 μm to 400 μm, 10 nm to 100 μm, 25 nm to 100 μm, 50 nm to 100 μm, 100 nm to 100 μm, 250 nm to 100 μm, 500 nm to 100 μm, 900 nm to 100 μm, 1 μm to 100 μm, 10 μm to 100 μm, 50 μm to 100 μm, 10 nm to 10 μm, 25 nm to 10 μm, 50 nm to 10 μm, 100 nm to 10 μm, 250 nm to 10 μm, 500 nm to 10 μm, 900 nm to 10 μm, or 1 μm to 10 μm, including any range therebetween.

As used herein the term “stable” refers to the capability of the article (e.g., a coated substrate) to maintain its structural and/or mechanical integrity such as being devoid of cracks and/or deformations. In some embodiments, the article is referred to as stable, if the article substantially maintains its structural and/or mechanical integrity under outdoor conditions such as a temperature −25 and 75° C., UV and/or visible light irradiation. In some embodiments, the stable article is rigid under outdoor conditions. In some embodiments, the stable article maintains its tensile strength and/or elasticity. In some embodiments, substantially is as described hereinbelow.

In some embodiments, the coating layer is stable at a temperature range of −100° C. to 100° C., −50° C. to 100° C., −10° C. to 100° C., −10° C. to 50° C., 0° C. to 100° C., 0° C. to 50° C., 5° C. to 60° C., 0° C. to 10° C., 10° C. to 100° C., 50° C. to 100° C., 10° C. to 50° C., 10° C. to 70° C., 5° C. to 60° C., including any range therebetween.

In some embodiments, the article comprises an outer surface and an inner surface, wherein the outer surface is in contact with or bound to the coating layer, as described herein.

In some embodiments, the composition of the invention is characterized by an adhesiveness property to the substrate.

In some embodiments, the coating layer is pesticide coating. In some embodiments, the coating layer has at least one characteristic selected from: an anti-fungal coating, an anti-microbial coating, an anti-insect coating, an anti-viral coating, an anti-mold coating, a plant protective coating, and a pesticide coating.

In some embodiments, the article or the pesticide composition of the invention is capable of reducing at least one of: (i) growth of the pest, and (ii) pest load on or within the substrate by at least 10%, at least 20%, at least 30%, at least 40%, at least 50%, at least 70%, at least 100%, including any range between compared to a control. In some embodiments, the article or the pesticide composition of the invention is capable of reducing at least one of (i) growth of the pest, and (ii) pest load at the application area (e.g., an area under cultivation and/or the substrate located in close proximity to the application site). In some embodiments, the control is a similar substrate being devoid of the pesticide composition of the invention (e.g., infested substrate which has not been treated by any pesticide composition). In some embodiments, the pesticide coating is capable of reducing pest load and/or pest growth by a factor ranging between 2 and 20, between 2 and 5, between 5 and 7, between 7 and 10, between 10 and 12, between 12 and 15, between 15 and 20, including any range between. In some embodiments, reducing is compared to the control.

In some embodiments, the coating layer according to the present invention, is stable under ambient conditions. In some embodiments, the coating layer is stable upon exposure to: an ambient temperature and/or temperature changes, heat, cold, UV radiation and atmospheric gases. In some embodiments, the characteristics of the coating layer are not affected or altered by climatic changes as described herein. In some embodiments, the article according to the present invention, is stable to climatic changes. In some embodiments, the article is stable to temperature changes, heat, cold, UV radiation and atmospheric corrosive elements. In some embodiments, the characteristics of the article (e.g., pesticide activity) are substantially not affected or altered by climatic changes as described herein.

In some embodiments, the article (e.g., a substrate coated by the pesticide composition) is stable for at least 1 d, least 5 d, at least 7 d, at least 10 d, at least 15 d, at least 30 d, at least 60 d, at least 100 d, at least 300 d, including any range between.

### The Method

According to some embodiments, the present invention provides a method for controlling a pest or reducing growth thereof, comprising contacting an effective of the pesticide composition with a locus infested with the pest.

The term “locus” as used herein, means a habitat, plant, seed, material, or environment, in which a pest is growing, may grow, or may traverse. For example, a locus may be: crops, trees, fruits, cereals, fodder species, vines, and/or ornamental plants, a plant part, the interior or exterior surfaces of buildings (such as places where grains are stored); the materials of construction used in buildings (such as impregnated wood). In some embodiments, the terms “locus” and “area under cultivation” are used herein interchangeably. In some embodiments, the terms “locus” refers to a plant and/or to a part of the plant (e.g., a leaf).

In some embodiments, there is a method for preventing infestation by a pest, the method comprises applying an effective amount of the pesticide composition of the invention to at least a portion of a plant, and/or to an area under cultivation. In some embodiments, there is a method for controlling a pest or reducing growth thereof, comprising applying an effective amount of the pesticide composition of the invention to at least a portion of a plant, or an area under cultivation infested with the pest, thereby controlling or reducing growth of the pest.

In some embodiments, the method is for killing a pathogen or for reducing pathogen load. In some embodiments, the method is for killing a pathogen or reducing growth thereof by administering to a plant an effective amount of the pesticide composition described hereinabove.

In some embodiments, the term “reducing”, or any grammatical derivative thereof, indicates that at least 20%, 30%, 40%, 50%, 60%, 70%, 80%, 90%, or more, reduction of growth or even complete growth inhibition in a given time as compared to the growth in that given time of the pathogen not being exposed to the treatment as described herein. In some embodiments, the term “completely inhibited”, or any grammatical derivative thereof, refers to 100% arrest of growth in a given time as compared to the growth in that given time of the pathogen not being exposed to the treatment as described herein. In some embodiments, the terms “completely inhibited” and “eradicated” including nay grammatical form thereof, are used herein interchangeably.

In some embodiments, the pesticide composition of the invention is characterized by adhesiveness to at least a part of the plant.

In some embodiments, the plant comprises a cultivating plant or a part thereof.

In some embodiments, the pesticide composition of the invention is applied to a plant or to a part of a plant via a method comprising: immersion, coating, irrigating, dipping, spraying, fogging, scattering, painting, injecting, or any combination thereof.

In some embodiments, the pesticide composition of the invention is applied at any plant cultivation stage, such as seeding, pre-seeding, pre-harvest, post-harvest, storage, etc.

In some embodiments, the effective amount is sufficient for controlling a pest, killing a pest, reducing pest load, reducing pest growth, reducing a plant damage associated with the pest, preventing infestation of a plant and/or area under cultivation by the pest, or any combination thereof.

In some embodiments, the pesticide effective amount is of the liquid composition disclosed herein at least 1 L/ha, at least 10 L/ha, at least 50 L/ha, at least 100 L/ha, at least 500 L/ha, at least 1000 L/ha, at least 5000 L/ha, including any range between.

### General

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “substantially” refers to at least 85%, at least 90%, at least 92%, at least 95%, at least 96%, at least 97%, at least 98%, at least 99% including any range or value therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

### Material and Methods

### Preparation of Water-In-Oil (W/O) Pickering Emulsion

Water-in-oil Pickering emulsions were prepared as follows. First, Aerosil® R202 (fumed silica treated with a polydimethylsiloxane and average primary particle size of 14 nm; Evonik, Germany) was dispersed in mineral oil (RTM10, Paragon Scientific, United Kingdom) at 1, 2 and 3 wt. %. The oil volume used were 50%, 60%, 70% and 80%. The silica in mineral oil was vigorously mixed at high speed with a vortex mixer until full dispersion. Next, Milli-Q water or PBS (10 mM phosphate buffer saline, pH 7.4) was added to the silica/oil dispersion to complete to a final volume of 10 ml for each sample. The water volumes used were 20%, 30%, 40% and 50%. The composition of the emulsions is detailed in Table 1. The water/silica-oil mixtures were homogenized using a high shear disperser T18 digital ULTRA-TURRAX® (IKA, Germany) with a 10 mm mixer head (S 18 D-10 G) for 2 min at 21,000 rpm to obtain inverse Pickering emulsions. The Pickering emulsions stability was confirmed by confocal microscopy and analyzed for droplet diameter. The emulsions were also observed by time for phase separation and coalescence.

TABLE 1
Composition of the emulsions used in this work

| | |
|---|---|
| AEROSIL ® R202 wt. % | Water:oil Vol % ratio |

| | | | | |
|---|---|---|---|---|
| 1 | 50:50 | 40:60 | 30:70 | 20:80 |
| 2 | 50:50 | 40:60 | 30:70 | 20:80 |
| 3 | 50:50 | 40:60 | 30:70 | 20:80 |

### Characterization of the Emulsions Type

The emulsions were characterized by labeling the hydrophobic particles and hydrophilic phase to identify the dispersed and continuous phase. The hydrophilic phase was labeled with 5(6)-Carboxyfluorescein (a stock solution of 1 mg/ml in DMSO), at a final concentration of 26.5 μM in 1 ml of PBS. After emulsion formation, the hydrophobic particles were labeled with Nile Red (a stock solution of 1 mg/5 ml in methanol) (Sigma-Aldrich) at a final concentration of 6.28 μM in 1 ml of emulsion. The labeled emulsions were analyzed by laser scanning confocal microscopy.

### Characterization of the Emulsion Type

The emulsions were characterized by labeling the hydrophobic particles and hydrophilic phase to identify the dispersed and continuous phase. The hydrophilic phase was labeled with 5(6)-Carboxyfluorescein (a stock solution of 1 mg/mL in DMSO), at a final concentration of 26.5 μM in 1 mL of PBS. After emulsion formation, the hydrophobic particles were labeled with Nile Red (a stock solution of 1 mg/5 mL in methanol) (Sigma-Aldrich) at a final concentration of 6.28 μM in 1 mL of emulsion. The labeled emulsions were analyzed by laser scanning confocal microscopy.

### Emulsion Viscosity

The viscosity of the emulsions was analyzed by a Thermo Scientific™ HAAKE™ MARS™ Rheometer using the shear rate ramp program. A rotational shear experiment ranging from 0.1-100 s-1 was carried out. For this, 800 μl of the sample was placed on parallel plate geometry with a diameter of 60 mm. The temperature of the plates was set to 25° C. Then, the top plate was lowered onto a plate separation of 0.053 mm, and the shear stress was applied to the sample.

### Bacterial Cell Culture and Growth Conditions—BtA Sporulation Assay

The bacterial strain Bacillus thuringiensis serovar aizawai (BtA) (Obtained from Biodalia Microbiological Technologies, Israel) was grown in a CCY medium and incubated in a rotary shaker (200 rpm) at 30° C. for two to five days. The BtA cell suspension were centrifuged at 8,000 rpm for 15 min at 4° C. The cell pellets, composed mainly of spores and a mixture of parasporal inclusion bodies, were washed with sterilized di-distilled water (ddH20) and kept at 4° C. until use. Microscopic observation at day five confirmed that more than 90% of the cells were lysed.

### Cell Fixation for Cryogenic Scanning Electron Microscopy Analysis

Two ml of three to five-day old bacterial cell cultures were centrifuged for one min at 12,000 rpm to remove media. Then, the cells were washed once for one min at 12,000 rpm with 10 mM of phosphate buffer saline pH 7.4. For fixation, 1 ml of 4% paraformaldehyde in water was added to the bacteria pellets, and the cells were resuspended and incubated at room temperature for 1 hour. After fixation, the cells were washed four times with PBS.

### Bacteria Preparation for Scanning Electron Microscopy Analysis

A 3-day-old BtA cell suspension was used for SEM analysis. First, the BtA cells were washed once with 10 mM PBS buffer pH 7.2 to remove the medium. Then, 100 μl taken from the sample were placed on 5 mm glass coverslips coated with polylysine and incubated at room temperature for 1 hour. Next, the liquid was removed, and the cells were fixed in 4% glutaraldehyde in 10 mM PBS pH 7.2 for 1 hour at room temperature. The fixed sample was washed five times with 10 mM PBS (pH 7.2). The sample was dehydrated in an ethanol series to 100% ethanol, and then critical point dried (K850 Critical Point Dryer, Quorom Technologies Ltd., East Sussex, UK). The dried samples were then mounted on aluminum stubs with carbon tape and sputter-coated with iridium or AuPd (Q150T ES Quorom Technologies Pvt. Ltd., East Sussex, UK).

### BtA Cell Labeling

The BtA cell culture was labeled with the LIVE/DEAD BacLight Bacterial Viability Kit (Invitrogen; the protocol was slightly modified with respect to the instructions provided with the kit). Two ml from three to five days of cell culture were washed once with 0.85% NaCl (5 minutes at 5000 rpm). The supernatant was removed and one ml of NaCl was added, and the cells resuspended. SYTO 9 dye (green signal) and Propidium iodide were added (red signal) at a ratio of 1:1 (1.5 ul+1.5 ul to 1 ml of bacterial suspension). The cells were incubated for 15 min at room temperature, protected from light while mixing in the Intelli-mixer tool. Then, cells were washed three times with 0.85% NaCl (5 min. at 5000 rpm). The Labeled cells were taken for confocal microscopy analysis.

### BtA Cell Encapsulation

BtA cells labelled as described in the previous section were incorporated into a W/O Pickering emulsion by vortex at high speed for 30 s. The cells were added to emulsions at a composition of 2 and 3 wt. % silica with a water/oil ratio of 20:80 and 30:70 respectively. For bioassay experiments, five days BtA cell suspension, containing spores and crystals, were washed once with PBS (5000 rpm, 5 min), and then added to the emulsions to give a final concentration of BtA. A few dilutions were used for cell encapsulation at 1:200, 1:100 and 1:50. Confocal laser scanning microscopy and image analysis.

Micrographs were obtained and analyzed by laser scanning confocal microscopy (Olympus, Fluoview 500). SYTO 9 and 5(6)-Carboxyfluorescein signals were detected using a multi argon laser with excitations at 488 nm, and the fluorescence emission was collected at 500-520 nm. The Propidium iodide and Nile Red signals were detected using a HeNe561 laser, with an excitation line at 561 nm, and the emission was collected at 570-613 nm. Bright field images of the emulsions were acquired with the HeNe561 laser. The droplet average diameter was measured for every sample by the particles analysis tool of Fiji software based on confocal microscopy images. The droplet average diameter was measured for every sample by the particles analysis tool of Fiji software based on confocal microscopy images.

### Scanning Electron Microscopy

Scanning electron microscope analysis was performed on a Jeol JSM 7800F HRSEM (Jeol Ltd., Tokyo, Japan) that incorporates 4 types of detectors, including an upper electron detector (UED), an upper secondary electron detector (USD), a backscattered electron detector (BED), and a lower electron detector (LED). Images were acquired with the upper electron detector (UED) or the lower electron detector (LED) at 3 k.

### Cryogenic-Field Emission Scanning Electron Microscopy

Cryogenic-field emission scanning electron microscopy (cryo-FESEM) analysis was performed on a JSM-7800F Schottky Field Emission Scanning Electron Microscope (Jeol Ltd., Tokyo/Japan). Liquid nitrogen was used in all heat exchange units of the cryogenic system (Quorum PP3010, Quorum Technologies Ltd., Laughton/United Kingdom). A small droplet of freshly mixed emulsion was placed on the sample holder between two rivets, quickly frozen in liquid nitrogen for a few seconds and transferred to the preparation chamber where it was fractured (at −140° C.). The revealed fractured surface was sublimed at −90° C. for 10 min to eliminate any presence of condensed ice and then coated with platinum. The temperature of the sample was kept constant at −140° C. Images were acquired with either a low electron detector (LED), or an upper electron detector (UED) at an accelerating voltage of 2-3 kV and a working distance of max. 4.5 mm.

### Insect Rearing

A Spodoptera littoralis colony was established in June 2016 and reared as described in Mechrez, G. et. al., Not Only a Formulation: The Effects of Pickering Emulsion on the Entomopathogenic Action of Metarhizium Brunneum. J. Fungi 2021, 7 (7), 499.

The colony was kept under a light regime of 12:12 (light: dark) and 26±2° C. Larvae are constantly fed on Ricinus communis leaves. To equalize the state of the larvae, all larvae used in the experiments were unfed 1st instar, 12 hours following hatching.

### Dose Response Assays

To define the optimal BtA concentration, a dose response assay was conducted. Ricinus communis leaf cuts were impregnated or sprayed with different spore concentrations of BtA cell suspension and water as a control. First, the surface of the leaves was sterilized by dipping the leaf for 15 seconds in a 0.4% (V/V) bleach solution, followed by two distilled water washes for 5 seconds, and were then dried. The leaves were cut into approximately square shaped equal sized bits. Then, the leaves were placed on 55 mm petri plates containing 2% agarose to provide humidity during the experiment. For the impregnation assay, the leaves were treated with BtA at concentrations of 10%, 15%, 20%, 25%, 30%, 40% and 50% in 0.05% Silwet L-77 (Adama, Israel). For the spray application, the leaves were treated with BtA concentrations of 10%, 20%, 30%, and 40% in 0.05% Silwet L-77. All the plates were left overnight for complete dry at room temperature. The next day leaf disks were assayed against S. littoralis 1st instars (n=50) larvae. Each treatment had five replicates, each replicate with ten larvae. Morality data were taken daily. The whole assay was repeated 3 times.

### Insect Assays

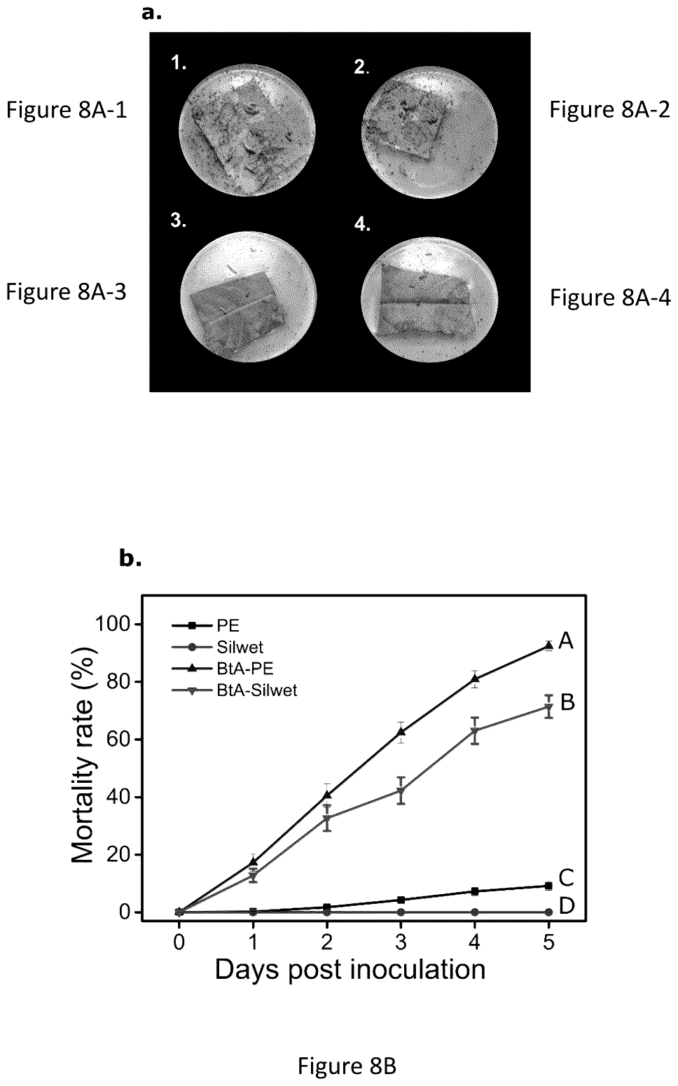

To assess the efficacy of the BtA in Pickering emulsion versus a water suspension, the same experimental setup as described above was implemented. Ricinus communis leaf cuts were placed on a 55 mm Petri dish containing 2% agarose to provide humidity during the experiment. Leaf cuts were impregnated with different treatments as follows: control (water only), 20% BtA cell culture, a Pickering emulsion at 3 wt. % silica and a water-oil ratio of 30:70 and a Pickering emulsion encapsulating the 20% BtA cell culture. Following impregnation, the plates were kept overnight at room temperature to dry completely. The following day the leaf cuts were infested with S. littoralis 1st instar larvae, with 10 larvae per plate (n=50) (FIG. 8a). Each treatment had five replicates, and mortality was checked daily. The whole assay was repeated 3 times.

### Statistical Analysis

All statistical analyses were performed using the JMP® software, version Pro-15 (SAS Institute Inc., USA). Graphs were plotted using OriginLab software. All tests were set to α=0.05. All experiments were repeated three times and repeats were counted as random blocks and were inserted in all analyses as random variables and analyzed using the restricted maximum likelihood (REML) method. Comparisons of mortality were carried out on the arcsine-transformed proportions of dead larvae and subjected to an analysis of standard least squares by REML followed by a Tukey HSD test for multiple comparisons among means. Data were subjected to LT50 (lethal time of 50% of the population) analysis by Probit (JMP package).

### Example 1

### Pickering Emulsion Preparation and Characterization

Inverse Pickering emulsions were prepared according to Table 1. The Pickering emulsion composition was 10 mM phosphate buffer saline at a pH 7.4 or Milli-Q water (MQ) for the cryogenic SEM experiments as the water phase and mineral oil RTM 10 with a viscosity of 20.4 mPa*s (at 25° C.) as the oil phase. The Pickering stabilizer was Aerosil® R202, a hydrophobic fumed silica surface-treated with polydimethylsiloxane, thus making it hydrophobic. The hydrophobic nature of the particles resulted in the formation of water-in-oil Pickering emulsions. The emulsions were prepared at water/oil phase ratios (vol %) of 20:80, 30:70, 40:60 and 50:50 respectively with silica contents of 1, 2 and 3 wt. %. In inverse emulsions, the water droplets were the dispersed phase, and the oil was the continuous phase. Since our main objective was to encapsulate bacteria, we chose an inverse emulsion system to maintain their viability. In the current invention, mineral oil has been utilized as the continuous phase without adding organic solvents to form an eco-friendly formulation. The encapsulation of bacteria in the water-in-oil Pickering emulsion has been implemented to compartmentalize the cells in a suitable buffer, which provided the bacteria with protection against pH changes and kept the bacteria viable.

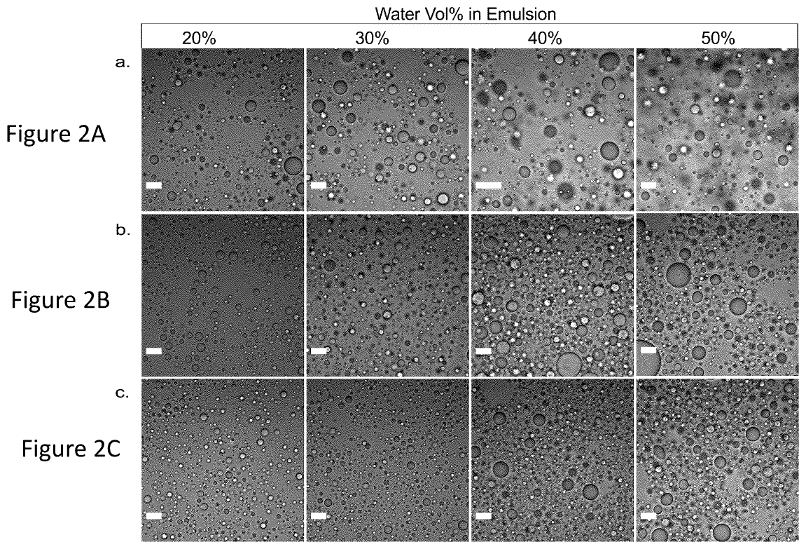

All the emulsions were characterized by laser scanning confocal microscopy to investigate their structure and stability. At time zero, 3 μl from each emulsion was taken and placed on a glass slide and analyzed. The emulsions of 2% and 3 wt % silica with 30% and 20% water remained stable for more than a year at ambient conditions. Among the emulsions of 1 wt. % silica, only the one with 20% water was stable for one month. The emulsions of 40:60 and 50:50 were not stable under the tested conditions. Confocal microscopy images of the emulsions are presented in FIG. 2. The results show the classical relationship between the minor phase volume and the particle content vs. the droplet size. A reduction in the water volume along with an increase in the silica contents resulted in a decrease in the droplet size. Increasing the silica contents at water volume fractions of 20% and 30% led to lower polydispersity of the droplet size, as shown in FIG. 2. On the other hand, emulsions of 40% and 50% water volume fractions were more polydispersed. The average droplet size for the stable emulsions was 7.28±3.11 m for 1 wt. % silica and 20% water, 6.28±1.46 m for 2 wt. % silica and 20% water, 5.88±2.23 m for 2% silica and 30% water, 5.56±1.4 m for 3 wt. % silica and 20% water and 5.55±1.49 m 3% silica and 30% water. Emulsions of 2 and 3 wt. % silica and water/oil ratios of 30:70 and 20:80 were selected for further investigation.

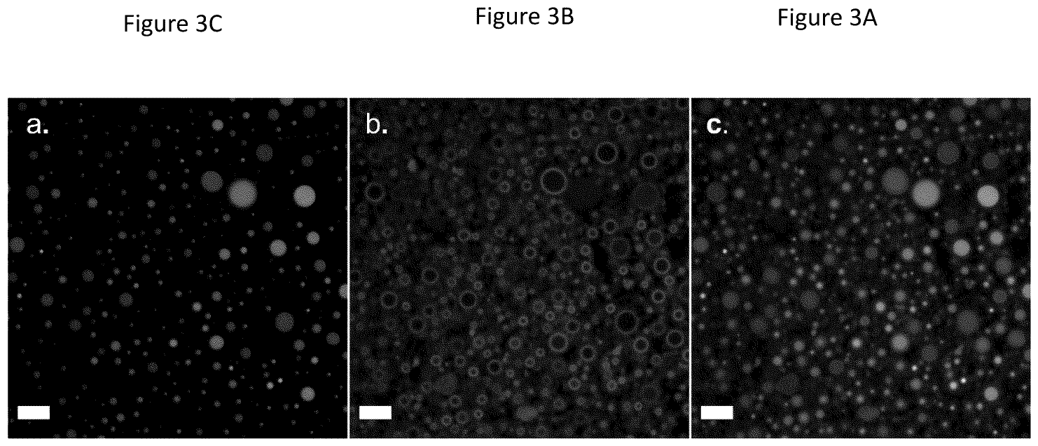

The type of the resulting emulsions (oil-in-water or water-in-oil) was studded by fluorescent confocal microscopy (FIG. 3). To this end, the silica particles and the aqueous phase were labeled, by selective fluorescent dyes. The hydrophobic silica particles were physically labeled with Nile Red (a lipophilic dye) and the aqueous phase was labeled with a water-soluble fluorescent molecule, 5(6)-Carboxyfluorescein (see Experimental section). The green labeling of the droplets confirmed the formation of inverse emulsions (water-in-oil) (FIG. 3a). In addition, the hydrophobic silica particles, which were physically labeled with Nile Red, created ring-like structures around the water droplets, confirming their presence at the interface as Pickering stabilizers (FIG. 3b).

### Rheology Analysis

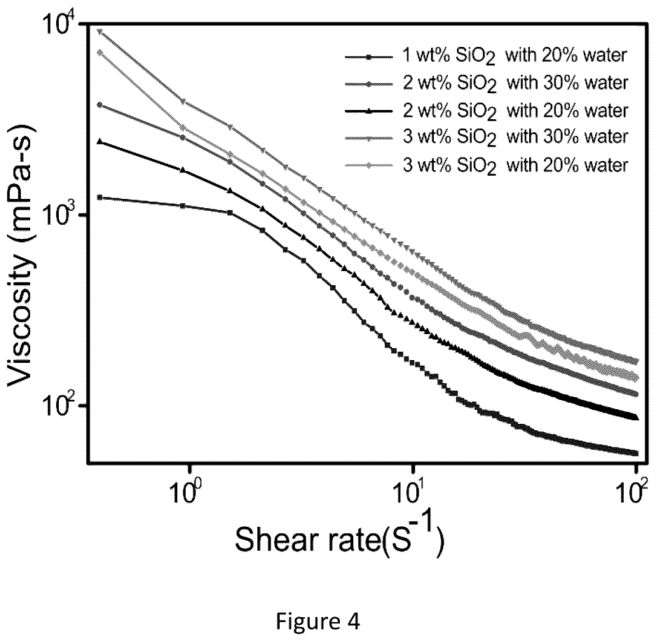

The flow properties of the five stable emulsions (2 and 3 wt. % silica each at water/oil ratios of 20:80 and 30:70, and 20:80 only for 1 wt. %) were characterized by a parallel plate rheometer using the shear rate ramp method, which measures viscosity vs. shear rate. The flow curves (viscosity vs. shear rate) of the different compositions are presented in FIG. 4. All the emulsions showed similar shear thinning behavior, typical for Pickering emulsions and emulsions in general. Increasing the silica contents at a given water volume fraction led to a decrease in the droplet size, which is expected to increase the viscosity. This finding results from the higher surface area per unit volume of the water droplets when their diameter decreases, resulting in higher drag forces during flow and therefore increases in the viscosity. Indeed, our results show that when the silica content is increased from 2% to 3 wt. % (at a water/oil ratio of 30:70), or from 1 to 3 wt. % (at a water/oil ratio 20:80), shear-thinning behavior is observed. In addition, a higher water volume fraction of 30% resulted in higher viscosity levels during shear thinning at silica contents of 2% and 3 wt. %.

### Example 2

### Bacterial Sporulation and Encapsulation

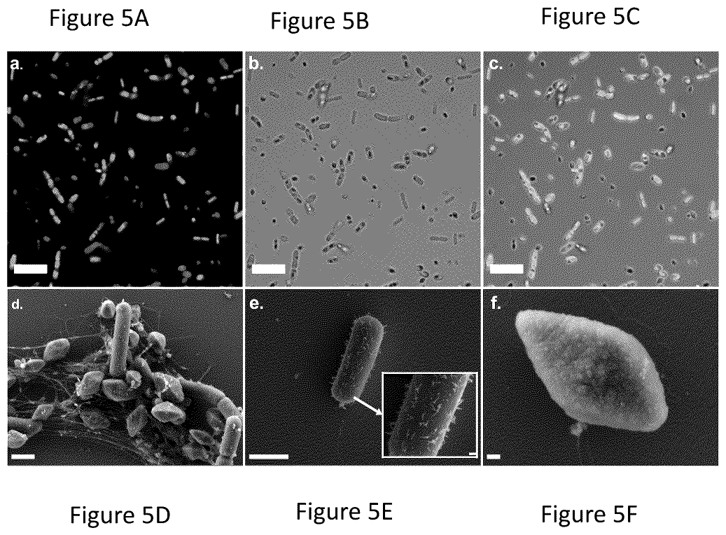

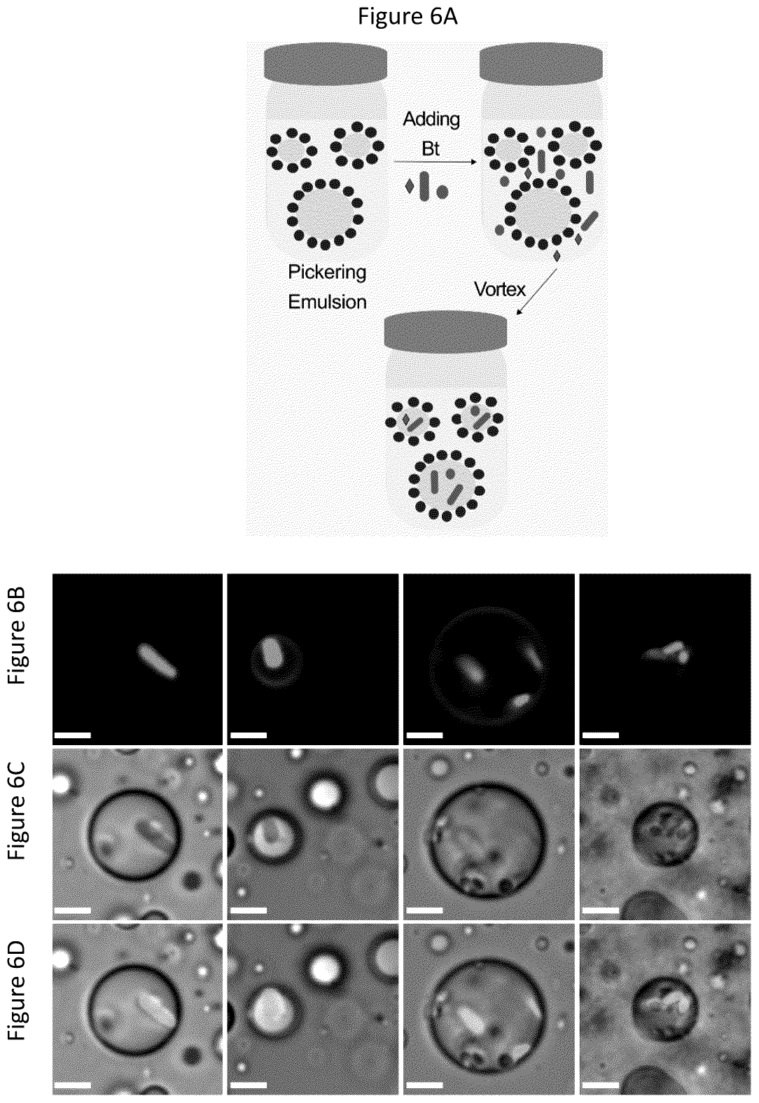

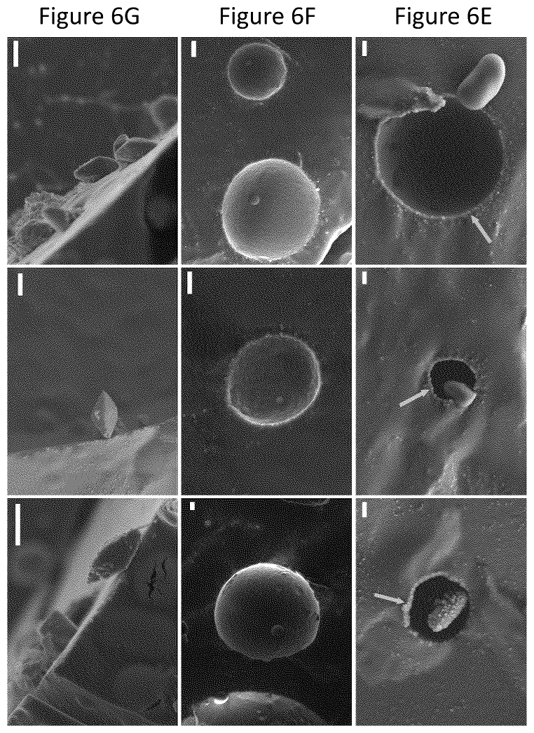

To study the sporulation process, BtA cells were observed at different stages of growth by confocal microscopy, HRSEM and Cryogenic SEM. Three-day-old sporulated cells are presented in FIG. 5. For the confocal experiments, the cells were stained with a Live/Dead cell staining kit containing SYTO 9 and Propidium Iodide dyes (see experimental section) which enabled us to monitor the bacterial cells (FIG. 5a-c). Live bacteria appeared as green and dead bacteria as red. The crystals are labeled in red, and spores are in green. SEM analysis of BtA cells required a special preparation of the bacterial sample to preserve their structure (see experimental section). The results are presented in FIG. 5d-f. A collection of bacteria, spores, and crystals are shown in FIG. 5d, bacteria alone in 5e and crystal in 5e. It can be seen that after three days of incubation, approximately 50% of BtA were sporulated. The confocal microscopy (FIG. 5a-c), cryo-SEM (FIG. 6e-g), and SEM (FIG. 5d-f) analysis have shown that the incubation time needed to obtain 90% sporulated cells was five days.

### Encapsulation of BtA Cell, Spores and Crystals in the Emulsions

The encapsulation experiments were carried out with stable emulsions at 2 and 3 wt. % silica with a water/oil ratio of 20:80 and 30:70 respectively. A schematic illustration of the encapsulation process is summarized in FIG. 6a based on the microscopy observations. Confocal microscopy images of a 3-day old BtA culture encapsulated in an emulsion of 3 wt. % silica and water/oil ratio of 30:70, are shown in FIG. 6b-d. Cryo SEM microscopy was performed at days two, three and five, to investigate the structure of the emulsions/BtA systems (see FIG. 6e-f). On day two, mainly vegetative bacteria (FIG. 6e) cells and some spores (FIG. 6f) were observed inside the water droplets. On day five, mainly crystals that were attached to the oil-water interface from the internal part of the droplet were observed (FIG. 6g). In addition, spores localized at the bottom of the water droplets (6f) were visible.

Some of the bacteria cells localized inside the droplets were coated with silica NPs. This may be explained by the fact that the bacteria first meet the oil during the encapsulation process and only then enter the water droplets during vortex. The Cryo SEM images show that the silica NPs are assembled at the water/oil interface. The particles can be easily identified by their relatively bright color (FIG. 6e-g).

### Example 3

### Pesticidal Activity of the Formulations

Dose Response of BtA Toward Spodoptera littoralis 1st Instar Larvae Following Two Application Methods

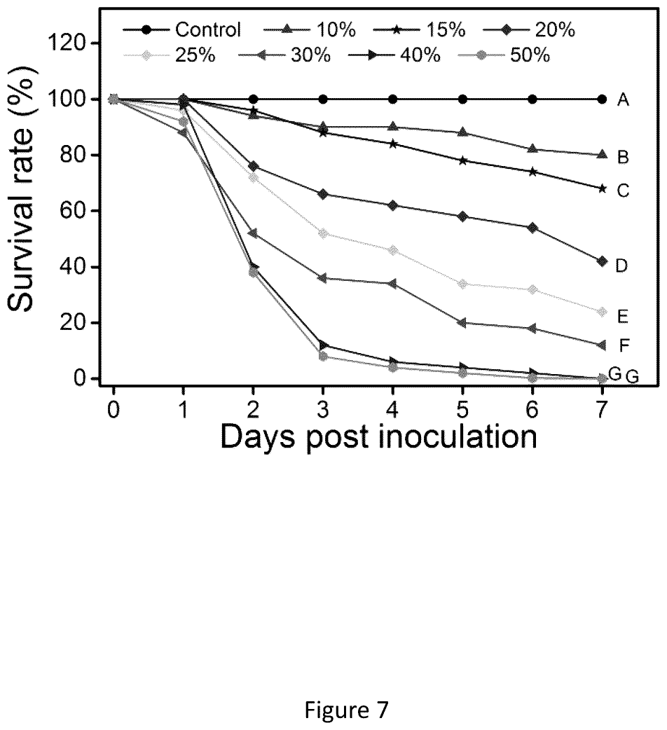

Calibration of the experimental system included a dose-response assay to determine the optimal spore concentration of BtA for bio assay experiments. Leaf cuts were impregnated with different spore concentrations of a five-day incubated BtA suspension assayed against S. littoralis 1st instars (n=50) (see experimental section). FIG. 7 shows a dose-response of the larvae. The LT50 analysis of leaf impregnation is summarized in Table 2 and indicates that the highest toxicity was obtained at 40% and 50% spores (v/v). A spore concentration of 20% in water suspension exhibited mediocre toxicity and therefore was chosen as the BtA concentration for the bioassay.

TABLE 2
List of BtA concentrations, LT₅₀, grouping LT₅₀ values
for Spodoptera littoralis larvae after leaf spray

| BtA spore | LT50 | Lower | Upper | Connecting |
|---|---|---|---|---|
| concentration (v/v) | Mean | 95% | 95% | letter* |
| 10% | 7.36 | 7.23 | 7.49 | B |
| 15% | 6.78 | 6.65 | 6.91 | C |
| 20% | 5.80 | 5.67 | 5.93 | D |
| 25% | 4.17 | 4.05 | 4.30 | E |
| 30% | 3.02 | 2.90 | 3.15 | F |
| 40% | 2.39 | 2.26 | 2.52 | G |
| 50% | 2.41 | 2.29 | 2.54 | G |

*Probit analysis (JMP) F = 1500.3, DF = 6, 13, P < 0.0001

Effect of BtA in an Aqueous Solution and a Pickering Emulsion on the Mortality Rates Of Spodoptera littoralis Neonates

The emulsion of 3 wt. % silica and water/oil ratio of 30:70, was studied in our bioassay against Spodoptera littoralis (see experimental section) due to its suitable droplet size and viscosity (FIG. 8A). Pickering emulsion and BtA encapsulated in Pickering emulsion (FIG. 8A3, 4 respectively) treatments showed a significant reduction in larvae feeding rates compared to the control (water) and BtA in an aqueous suspension (FIG. 8A1, 2 respectively). The mortality rate reached 92% at the BtA encapsulated in the inverse Pickering emulsion, which was significantly higher than the BtA suspended in an aqueous solution for which the mortality was 71.4% (fit of the least square response of Sample×Time: F=184.623, DF=3, P<0.0001; Sample: F=606.08, DF=3, P<0.0001; FIG. 8b). The emulsion without BtA resulted in a mortality rate of 9%, indicating its low toxicity. The LT50 analysis revealed that the BtA in the Pickering emulsion resulted in significantly higher mortality rates among all treatments (Table 3; F=517.51, DF=7, P<0.0001).

These results show a correlation with our recent studies in the field of microbial biopesticide encapsulation in Pickering emulsion. We have demonstrated the successful encapsulation of Metarhizum brunneum conidia in oil-in-water Pickering emulsions, which resulted in higher conidia distribution on the leaves, enhanced UV protection and synergistic effect in S. littoralis larvae control.

TABLE 3
List of treatments, LT₅₀, grouping LT₅₀ values for Spodoptera littoralis
larvae following leaf impregnation with BtA at 20% v/v of spores in
the native state and formulated in a Pickering emulsion.

| | LT₅₀ | Lower | Upper | Grouping |
|---|---|---|---|---|
| Treatment | (days) | 95% | 95% | LT₅₀ |
| BtA aqueous suspension | 4.28 | 3.53 | 4.90 | B |
| BtA Pickering emulsion | 3.40 | 3.23 | 3.97 | A |
| Pickering emulsion | 6.90 | 6.53 | 7.54 | C |
| Aqueous suspension | — | 12.116 | 30.418 | D |

Grouping LT50 with no letters in common were significantly different (χ=5376.8, DF=7, P<0.0001)

To this end, the inventors developed a Bacillus thuringiensis formulation based on a water-in-oil Pickering emulsion stabilized by hydrophobic silica nanoparticles. The emulsions were analyzed by confocal and electron microscopy and a rheometer for further characterization. The sporulated BtA cells were then encapsulated into water droplets and tested against S. littoralis 1^{st} instar larvae. The bioassay results exhibited a high mortality rate of 92% for the developed formulation encapsulating BtA, whereas the BtA cell suspension in water resulted in 71.4% mortality. Control samples showed 0% for water and only 9% for the emulsion alone. The very low toxicity of the emulsion alone promises that only insects that are targeted by Bt will be harmed. These findings clarify that the emulsion with BtA cells functioned as a pesticide and performed better against the target pest than the BtA in water suspension.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A composition, comprising core-shell particles dispersed within a hydrophobic solvent, wherein:
each of the core-shell particles comprises a liquid core enclosed by a shell comprising hydrophobic nanoparticles;
the liquid core comprises an aqueous solution and at least one microbial cell, a spore thereof, or a combination thereof,
a w/w concentration of the hydrophobic nanoparticles within the composition is between 0.1 and 10%;
a w/w ratio between the aqueous solution and the hydrophobic solvent is between 5:95 and 40:60; and
said hydrophobic nanoparticles comprise a chemically modified metal oxide nanoparticle.

2. The composition of claim 1, wherein said metal oxide comprises nano clay, SiO₂, TiO₂, Al₂O₃, Fe₂O₃, ZnO, and ZrO or any combination thereof.

3. The composition of claim 2, wherein said chemical modification comprises any of (C1-C20)alkyl, (C1-C20)alkyl silane group, vinyl, epoxy, a cycloalkane, an alkene, an alkyne, an ether, a silyl group, and a siloxane group, or any combination thereof.

4. The composition of claim 1, wherein a w/w concentration of said core-shell particles within said composition is between 5% and 70%.

5. The composition of claim 1, wherein said core-shell particle is a sphere characterized by an average particle size between 1 μm and 50 μm; and wherein said shell has a thickness of 10 nm to 500 nm.

6. (canceled)

7. (canceled)

8. The composition of claim 1, wherein the microbial cell or the spore thereof comprises a bacterium, a fungus or a combination thereof.

9. The composition of claim 1, wherein said bacterium comprises a Bacillus specie.

10. The composition of claim 9, wherein the Bacillus specie Bacillus thuringiensis.

11. The composition of claim 10, wherein said composition is a water in oil Pickering emulsion; wherein said hydrophobic solvent is water immiscible and is characterized by a dipole moment of between 0 and 0.3; and wherein said hydrophobic solvent is characterized by viscosity at 25 C between 1 and 100 cP.

12. (canceled)

13. (canceled)

14. The composition of claim 1, wherein said hydrophobic solvent is substantially non-toxic to the microbial cell or to the spore thereof; and wherein said hydrophobic solvent is substantially devoid of phytotoxicity.

15. The composition of claim 1, wherein said hydrophobic solvent comprises a mineral oil, a C10-C30 aliphatic hydrocarbon, a fatty acid, a monoglyceride, a diglyceride, a triglyceride, a vegetable oil, wax, an essential oil, an aromatic oil, or any combination thereof.

16. A pesticide composition comprising the composition of claim 1, wherein said microbial cell, the spore thereof or both is characterized by a pesticidal activity.

17. The pesticide composition of claim 16, formulated for spraying or coating and is characterized by a viscosity between 10³ and 10⁵ cP; and wherein said pesticide composition comprises a pesticidal effective amount of said microbial cells, spores, or any combination thereof.

18. (canceled)

19. The pesticide composition of claim 17, wherein the pesticidal effective amount comprises a concentration of said microbial cells, spores, or any combination thereof of at least 10% v/v.

20. (canceled)

21. (canceled)

22. (canceled)

23. (canceled)

24. (canceled)

25. (canceled)

26. A method for controlling a pest, comprising applying an effective amount of the pesticide composition of claim 16 to at least a portion of a plant, or to an area under cultivation infested with said pest, thereby controlling or reducing growth of said pest.

27. The method of claim 26, wherein said pesticide composition is characterized by adhesiveness to at least a part of said plant; wherein said pest is a plant pest, a soil pest or both and is selected from an insect, an aphid, a nematode, a wireworm, a fungus, and a microorganism or any combination thereof; and wherein said applying comprises any of immersion, soaking, coating, irrigating, dipping, spraying, fogging, scattering, painting, injecting, or any combination thereof.

28. (canceled)

29. (canceled)

30. The method of claim 26, wherein said effective amount is between 1 and 1000 L/ha.

31. (canceled)
